(19) United States
(12) Patent Application Publication
(10) Pub. No.: US 2024/0254369 A1
(43) Pub. Date: Aug. 1, 2024

(54) FLAME RETARDANT HOT MELT ADHESIVE

(71) Applicant: COLQUÍMICA-INDÚSTRIA NACIONAL DE COLAS, S.A, Valongo (PT)

(72) Inventors: Cristina Isabel FERNANDES FRUTUOSO, Matosinhos (PT); Jessica Alexandra REIS PEREIRA, Vila Nova de Gaia (PT)

(21) Appl. No.: 18/635,744

(22) Filed: Apr. 15, 2024

Related U.S. Application Data
(63) Continuation-in-part of application No. PCT/IB2022/059740, filed on Oct. 11, 2022.

(30) Foreign Application Priority Data
Oct. 15, 2021 (PT) 117520

(51) Int. Cl. C09J 7/35; C09J 11/06; C09J 123/08; C09J 123/14; C09J 123/20

(52) U.S. Cl. CPC C09J 7/35; C09J 11/06; C09J 123/08; C09J 123/14; C09J 123/20; C09J 2301/304; C09J 2301/312; C09J 2301/408; C09J 2301/414; C09J 2301/50

(57) ABSTRACT

The present invention refers to a hot melt adhesive for use in the furniture industry, more specifically in the construction of mattresses. One of the objectives of this invention is the creation of a hot melt adhesive that (i) has a rheological behavior and consequently technical characteristics such as open time and setting time properly adjusted to the production process used in this industry, (ii) has negligible residual stickiness, which allows it to be produced in the form of granules or pearls and stored without agglomeration of the granules, (iii) eliminates the occurrence of noise during the use of the mattress due to the absence of residual stickiness, (iv) has a flame retardant behavior when compared to formulations typically used for this industry.

This application is a continuation pf PCT/IB2022/059740. filed 11 Oct. 2022, which claims priority to and the benefit of Portuguese Application No. 117520, filed 15 Oct. 2024, the entireties of which are hereby incorporated herein by reference.

### FIELD OF THE INVENTION

The present invention falls within the scope of hot melt adhesives and relates more particularly to a hot melt adhesive for use in the furniture more industry, specifically for mattress construction. The composition of this invention makes it possible to produce a hot melt adhesive whose rheology is properly adjusted to the production process of mattresses on an industrial scale, as well as to its extrusion in the format of granules or pearls. Additionally, it has negligible residual, i.e., substantially equal to zero, tackiness, which allows it to be produced in the form of granules or pearls and stored without agglomeration of the granules and has a flame-retardant behavior when compared to formulations typically used for this industry.

### BACKGROUND OF INVENTION

The invention falls within the hot melt adhesive industry. Hot melt adhesives are products that are applied to the surface of a material in a molten state at high temperatures and harden when cooled to form a bond between at least two materials. Thereby, these products are supplied to in a solid state and, later, heated and applied in a liquid state. In general, the application temperature of this type of product varies between 120 and 200° C. Hot melt adhesives are used in a wide variety of industrial applications worldwide and are able to respond to a wide range of complex requirements in the adhesive industry. The hot melt adhesive market has seen exponential growth in recent decades due to the large-scale production of synthetic polymers. In addition to the economic advantages, these types of adhesives also do not include organic solvents in their composition, which makes them an option of choice due to the strong focus on sustainability that exists in this industry.

Currently, a hot melt adhesive considered standard for use in the mattress industry is comprised of a polymeric component, a resin component, and a plasticizer. In addition it may contain other components such as waxes and antioxidants, depending on the desired properties of e final product. Regarding the mentioned properties, it is extremely important that these adhesives present a strong adhesion performance with the different types of foam and textile materials that are used as raw materials. In addition, the adhesives used in this type of industry must guarantee adequate flexibility for the characteristic mobility of the materials that make up the final product. Additionally, the production process in this industry is characterized by a combination of automatic and manual processes, which requires adaptability on the part of the adhesive used to variable production times, an inevitable consequence associated with the manual process. Finally, adhesives intended for this industry should preferably have a rheology that allows their efficient use at a temperature between 140 and 170° C.

### FRAMEWORK OF THE INVENTION

Typically, hot melt adhesives used in the construction of mattresses have a polymeric base consisting of amorphous alpha polyolefin (APAO) polymers or styrene copolymers. These polymers are chosen because of their rheology, as they allow the hot melt adhesive to have an open time and setting time suitable for the production process.

As previously mentioned, the construction of mattresses is a process that is heavily dependent on the manual work of the operators of the production lines. For this reason, open time and setting time are extremely important properties when selecting the adhesive to be used. Moreover, human error is a factor that constantly affects production time in this industry. A difficulty frequently mentioned by mattress producers, who use hot melt adhesives, is the inconvenience associated with manually feeding the adhesive tanks. This process is carried out by operators who, at the same time, are responsible for several other tasks. For this reason, the need to check the adhesive level in the tank is often overlooked, which results in stoppages in the production line to wait for it to be fed and then for the adhesive to melt.

A solution to this inconvenience would be the automatic feeding of the adhesive tanks. However, this type of system only works when the hot melt adhesive is in the form of granules or pearls with weights between 4 and 6 mg each, since a suction hose is used that directly transports the adhesive from the bag to the tank. However, these compositions based on APAO polymers or styrene copolymers have high residual tack, implying that the adhesive is extruded with a protective film on the surface to prevent agglomeration of the adhesive units. For this reason, these compositions cannot be extruded in the form of granules or pearls. Additionally, a consequence associated with the manual mattress construction process is the inefficient assembly of foam pieces. If the foams are not bonded properly, areas are created where adhesive is applied that is not performing its function of bonding two substrates. In these areas, the adhesive appears on the surface of the foam and in contact with the air. During use of the final product, pressure is applied to these areas and the foam encounters the surface of the adhesive, which is traditionally tacky. This movement creates noise, which in turn is one of the main sources of complaints in the mattress industry.

### BACKGROUND OF THE INVENTION

Documents CN104449465A and CN103805112A describe the composition of two hot melt adhesives whose polymeric base consists of amorphous alpha polyolefin polymers or styrene copolymers, respectively. In these documents, non-toxic and environmentally conscious constituents are highlighted. Both polymeric bases mentioned are made up of polymers with considerable residual tackiness, so the supply format of these products will have to be suitable for this property (i.e. pads, blocks, etc.). For this reason, these compositions are not suitable to solve the technical problem of the present invention.

On the other hand, the furniture industry is subject to strict legislation regarding the flammability of products such as mattresses. As of 2007, all mattresses sold in the United States have been required to meet federal guidelines for flame resistance. The same is true in the UK. The guidelines and legislation applied are necessary since their implementation prevents not only extensive material damage, but also physical injuries, even allowing to save lives. This concern is especially present in the market for baby mattresses. Since they spend around eighteen hours a day sleeping, so safety in the resting place is considered crucial.

Traditionally, flame retardant chemicals are added to mattresses so that they can satisfy flammability requirements. However, according to the legislation, the presence of this type of substance is not mandatory. Only the behavior of the product in the face of contact with the flame is relevant. Unfortunately, most of the flameretardant compounds used in this market are toxic and prolonged exposure to this type of compound has been linked to the onset of diseases such as cancer, endocrine disorders, cardiovascular diseases, and even cognitive delays. Babies and children are especially at risk as their immune systems are still developing. Examples of toxic chemical compounds used as flame retardants are polybrominated diphenyl ethers (PBDEs), boric acid, antimony trioxide, decabromodiphenyl oxide and vinylidene chloride.

The inventions mentioned above do not have fire-retardant properties, representing only hot melt adhesives typically used in the mattress construction industry. In this sense, there are documents such as CN103815701A which refers to a mattress whose constitution has a flameretardant effect. Through the combination of holes arranged on both sides of the mattress body with the flame-retardant constituent materials (foam, fabric and non-woven) this invention allows direct contact with a source of flame resulting in only the top layer of the mattress being charred, without starting the combustion of the entire structure. Similarly, document U.S. Pat. No. 7,484,256B2 describes a mattress cover which is placed on the surface of the mattress forming a protective layer. In this way, despite direct contact with the flame, there is no combustion on the part of the mattress.

Furthermore, regarding hot melt adhesives with flame retardant properties, only documents such as CN106221629B or CN111849396 are found where the hot melt adhesive compositions are described which have in their formulation an additive component whose objective is to grant flame retardant properties to the adhesive.

### Advantages of the Invention

Analyzing the state of the art, it is possible to conclude that the hot melt adhesives used in the furniture industry for the construction of mattresses are produced in formats that imply the manual feeding of the adhesive tanks used in the production lines. Due to their high residual tack and a rheological behavior that does not allow the extrusion in granule or pearls format.

The implementation of an automatic feeding method results in significant reductions in production times, as the chance of the amount of adhesive in the tank reaching too low a level is eliminated. Thus, the production process is optimized.

The present invention concerns a hot melt adhesive that has a rheology that allows its production in the form of granules or pearls, which allows automatic feeding of the tanks.

Furthermore, the present invention relates to a hot melt adhesive with negligible residual tack at room temperature after solidification. For this reason, concerns regarding the frequent noise problem associated with the use of hot melts for mattress construction are eliminated.

Finally, in the formulation used in the present invention, no functional additive is used to delay the ignition of the adhesive when exposed to flame. Thus, the use of the hot melt adhesive described in this invention does not imply prolonged exposure to potentially toxic compounds that are traditionally used to provide flame resistance in hot melt adhesives. That is, the hot melt adhesive of the invention does not have in its constitution any additive typically used as a flame retardant in the industry, however, it unexpectedly manages to show resistance to direct exposure to flame. This unexpected effect became evident after carrying out the test according to the European standard DIN EN ISO 11 925, obtaining an “E” rating.

### DETAILED DESCRIPTION OF THE INVENTION

By “substrate” is meant the material or the surface of the material on which the hot melt adhesive is applied and/or directly contacted. In the context of mattress construction, the most common substrates are polyurethane foams.

By “open time” is meant the maximum time interval after the hot melt adhesive is applied to the first substrate when it is possible to effectively bond a second substrate.

By “setting time” is meant the minimum time interval in which pressure is required to be applied for two substrates to bond effectively. Thus, the setting time is associated with the speed with which the adhesive recovers its cohesive strength.

By “adequate rheological behavior” is meant the change in material properties with temperature, which results in adequate technical properties such as open time and setting time.

By “polymer base” is meant the polymeric materials that contribute to the fundamental properties of the composition and form the foundation of the composition. Thus, the remaining components of the formulation have the function of altering or improving properties of the polymeric base.

By “DIN EN ISO” is meant the teste performed according with national (DIN), European (EN) and international (ISO) standards for hot melt adhesives.

By “ASTM” is meant the tests performed according to the American Society for Testing and Materials.

The object of the present invention is a hot melt adhesive for the furniture industry, but not namely, exclusively, in the manufacture of mattresses. This hot melt adhesive has a rheological behavior that results in properties such as viscosity, open time and setting time suitable for use in mattress construction, in the temperature range used (140 to 170° C.). These features allow its extrusion in the form of granules or pearls.

Yet another objective of the present invention is a hot melt adhesive with an increased flame resistance, compared to other hot melt adhesives that exist on the market and do not have flame retardant additives.

According to the invention, the hot melt adhesive used in mattress manufacturing comprises:
a polymeric component comprising at least one polyolefin thermoplastic polymer, more specifically, at least one copolymer of butene olefins, propylene and ethylene.
a resin component comprising at least one resin of natural or synthetic origin.
a plasticizing component comprising at least one plasticizer capable of controlling rheological properties like viscosity.
an antioxidant component comprising at least one phenolic antioxidant capable of preventing degradation of the adhesive due to high temperature exposure.
an additive component comprising at least one sliding agent capable of reducing the coefficient of friction between surfaces and prevent unwanted adhesion (agglomeration of adhesive granules when stored).

Since the basis of this invention is a hot melt adhesive, properties such as adhesion, cohesion, open and setting time, among others, cannot be neglected.

### Polymeric Component

The hot melt adhesive intended for application in the furniture industry, namely, but not exclusively, in the manufacture of mattresses, must include a polymeric component comprising at least one thermoplastic polymer capable of guaranteeing properties such as open time and setting time suitable for its application in mattress construction. In addition, the polymeric component should make it possible to obtain a hot melt adhesive with reduced tackiness after solidification.

Furthermore, the polymeric base used should allow an increase in resistance to direct exposure to flame, compared to the state of the art. More specifically, it must allow the hot melt adhesive to have a flameretardant classification according to the European standard DIN EN ISO 11 925-2. Suitable polymers for the adhesive of the present invention may be selected, namely, but not exclusively, from: copolymers of olefins of butene, propylene, and ethylene.

The polymeric component comprises up to 70% by weight of the hot melt adhesive, preferably between 15% and 60%, more preferably between 30% and 60%, more precisely between 50% e 55%.

### Resin Component

The main objective of the resin component is to ensure adequate adhesion to the materials used, namely foams, textiles and non-woven fabrics.

The adhesive of the present invention contains a resin component comprising resin of natural or synthetic origin.

If the resin component is a natural resin, this natural resin is selected, namely, but not exclusively, from: rosin resins, glycerol, pentaerythrol, triethylene glycol or methyl ester rosin, partially or fully hydrogenated rosin resin, of Tall Oil, glycerol, pentaerythrol or methanol ester of Tall Oil resin, polyterpene resin or terpene phenolic resin.

In case the resin component is a synthetic resin, this synthetic resin is selected, namely, but not exclusively, from: pure monomer resin or hydrocarbon resin. Preferably, a hydrocarbon resin which may be selected, namely, but not exclusively, from: aliphatic (C5), aromatic (C9), aliphatic-aromatic (C5/C9) and dicyclopentadiene (DCPD) resins, more preferably aromatic (C9), even more preferably hydrogenated aromatic (C9) and hydrogenated dicyclopentadiene (DCPD).

The resin content corresponds to up to 60% by weight of the hot melt adhesive, more preferably between 10% and 55%, even more preferably between 25% and 50%, more precisely between 40% and 50%.

### Plasticizer Component

The use of the plasticizer component allows the adjustment of the viscosity and softening point of the hot melt adhesive to values considered adequate, so that it can be easily applied in industrial production lines. “Suitable viscosity” is understood as a viscosity value at 160° C. between 1 000 and 10 000 mPa·s, more preferably between 1 500 and 8 000 mPa·s and even more preferably between 2 000 and 5 000 mPa·s. By “suitable softening point” is meant a softening point value comprised between 50 and 130° C., more preferably between 55 and 120° C., and even more preferably between 60 and 115° C. By ensuring that the formulation has the proper values for these two properties, it is also ensured that the application temperature necessary when using the adhesive of the invention in industrial lines is adequate and that it must be between 100 and 200° C., more preferably between 120 and 180° C., and even more preferably between 140 and 170° C.

In addition, the plasticizer component must allow, through mixing with the polymer component, the hot melt adhesive to present an open time and setting time suitable for the production process of mattresses.

For this reason, preference is given to a plasticizer component comprising at least one liquid plasticizer at room temperature, which can be selected, namely but not exclusively, from liquid polymers, saturated hydrocarbons, mineral oils, naphthenic or hydrotreated paraffinic oils, preferably isobutylene-butene copolymer.

The content of the plasticizer component used corresponds to up to 20% by mass of the hot melt adhesive, more preferably between 1% and 15%, even more preferably between 2% and 10%, more precisely between 2% and 4.5%.

### Antioxidant Component

The use of the antioxidant component aims to avoid the degradation of the hot melt adhesive by exposure to high temperature, either during its production, during application or during storage of the final product. Particularly useful for the present invention is the use of an antioxidant component comprising at least one primary, secondary or multifunctional antioxidants. Thus, suitable antioxidants can be selected from: phenolic antioxidants, phosphite antioxidants, thio-esters antioxidants or mixtures thereof.

The content of the antioxidant component suitable for the present invention corresponds to up to 5% by weight of the hot melt adhesive, more preferably between 0.1% and 4% and even more preferably between 0.2% and 2%, more exactly between 0.5% and 1.5%.

### Additive Component

The use of the additive component aims to avoid the agglomeration of the hot melt adhesive as consequence of pressure applied during storage of the product. The additive component should comprise at least one sliding agent capable of reducing the coefficient of friction between surfaces and preventing unwanted adhesion.

Suitable additives for the adhesive of the present invention may be selected, namely, but not exclusively, from: ethylene bisstearamide (EBS), ethylene bisoleamide (EBO), erucamide or erucic acid, etc.

The sliding additive component corresponds to up to 5% by weight of the hot melt adhesive, preferably between 0, 3% and 3%.

Eventually, other components may be added in order to change specific properties or the performance of the hot melt adhesive for mattress construction. For example, if it is desired to reduce the open time or reduce the tackiness at room temperature of the hot melt adhesive, waxes can be added to its composition.

### Production Method

The method to produce hot melt adhesive for mattress construction comprises:
1. Mixing, the plasticizer component and the resin component at a temperature between 130 and 150° C., until a homogeneous paste is formed. The process is started with these components, since they have low viscosity and, therefore, allow a uniform and rapid melting only by the action of temperature, without the need for agitation inside the mixer.
2. Add constant stirring to the paste formed. After this mixture, the antioxidant component is added. It is important that it is added at this stage as it will prevent the degradation of the properties of resin component by prolonged exposure to temperature. It should not be added before resin component due to its very fine solid powder form, which makes it very difficult to mix with plasticizer component.
3. Additive component should be added immediately after antioxidant component, as this is a very small amount and should melt quickly.
4. Next, this paste is mixed with polymeric component with constant stirring. This component is the most challenging to incorporate into the mix, due to its high viscosity. A constant temperature, selected between 130 and 150° C., must be maintained, as well as constant agitation, until it melts completely and the mixture presents a translucent, uniform, homogeneous and fluid appearance.

### Embodiments of the Invention

To verify the results obtained with this formulation, as well as comparing it with other hot melt adhesives used in the manufacture of mattresses, several tests were performed, and their results are shown in Table 1.

This invention is further illustrated by the following non-limiting examples.

In Example 1 is shown the information of a formulation of a hot melt adhesive for mattress construction with technical properties, namely open time, viscosity and softening point considered appropriate. However, this composition has a rheology that does not allow its production in form of granules or pearls, so it is not considered suitable for the present invention and is presented for comparison purposes only.

In Example 2 are presented the results of a hot melt adhesive whose formulation was altered so that the rheology of the adhesive allows its production in granules or pearls. Additionally, technical properties such as open time, viscosity and softening point are considered appropriate for mattress construction. Despite this, the formulation has a polymer base which results in a hot melt adhesive with considerable residual tack (Table 1) after solidification. Therefore, during storage the granules or pearls agglomerate in the bag due to the pressure exerted by their own weight. For this reason, this formulation is not considered suitable for delivery in granules or pearls format.

To overcome this difficulty, the polymer base was changed to vinyl acetate polymers, which do not have negligible residual tackiness and are typically used in formulations intended to be produced in a pearl or granulated format. The technical properties were optimized by adjusting the remaining components. However, this formulation was tested on an industrial mattress production line and failed. Example 3 was reproved since it did not have adequate open time (too short) (Table 1).

The optimization of the properties mentioned in Example 3 was possible by changing the polymeric component to one typically used in the formulation of hot melt adhesives for other applications, such as the packaging industry. Simultaneously, for this change to be possible, it was also necessary to adjust the resin and plasticizer components, to obtain a hot melt adhesive with an open time and setting time suitable for the construction of mattresses. It is important to note that the hot melt adhesive to which this invention relates has an open time considerably lower than those typically observed in the industry, as a result of the change in the polymeric base of the adhesive. However, it was possible to obtain an adequate open time to produce mattresses, having carried out a large number of tests in industrial production lines with favorable results. The combination of the mentioned components made it possible to obtain a formulation with all the desirable technical characteristics, Example 4: good adhesive capacity, softening point and viscosity that allow easy application at the desired temperature and open time and setting time suitable for the application process used. In addition, an adhesive with rheology suitable for production in format of granules or pearls was obtained. Finally, although the polymeric base used allows to obtain a polymer with negligible residual tackiness, an additive component was added, which corresponds to a sliding agent capable of reducing the coefficient of friction between surfaces. The addition of this component makes it possible to reduce the agglomeration of the granules or pearls during storage, so it is typically added to formulations that are intended to be produced in this format.

Finally, the formulations corresponding to Example 1 and Example 4 were tested in accordance with the European standard DIN EN ISO 11 925, and an “E” rating was obtained only in the case of Example 4. The alternative formulation failed the mentioned test. In this way, the improvement in relation to the flameretardant character obtained by changing the chemical base is proven. For comparison purposes only, Example 5 is shown in Table 1, which corresponds to a hot melt adhesive that has a flameretardant additive, more specifically piperazine pyrophosphate. This formulation is not considered suitable for the construction of mattresses and is only included for comparison of the classification in the test carried out to determine the flame resistance capacity.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

TABLE 1

| | Example | Example | Example | Example | Example |
|---|---|---|---|---|---|
| | 1 | 2 | 3 | 4 | 5 |
| Resin | 40.2% | 48.9% | 50.0% | 44.5% | 47.5% |
| Component ^{A} | | | | | |
| Plasticizer | 14.5% | 5.0% | 2.0% | 4.5% | 3.6% |
| Component ^{B} | | | | | |
| Polymeric | 44.8% | 45.6% | — | — | — |
| Component 1^{C} | | | | | |
| Polymeric | — | — | 45.5% | — | — |
| Component 2^{D} | | | | | |
| Polymeric | — | — | — | 50.0% | — |
| Component 3^{E} | | | | | |
| Polymeric | — | — | — | — | 20.1% |
| Component 4^{F} | | | | | |
| Antioxidant | 0.5% | 0.5% | 0.5% | 0.5% | 0.8% |
| Component ^{G} | | | | | |
| Sliding Additive | — | — | 2% | 0.5% | — |
| Component ^{H} | | | | | |
| Flame Retardant | — | — | — | — | 28% |
| Additive | | | | | |
| Component | | | | | |
| Viscosity at | 2 200 | 2 800 | 4 150 | 3 100 | 30 000 |
| 160° C.^{#1} | mPa · s | mPa · s | mPa · s | mPa · s | mPa · s |
| Softening Point ^{#2} | 98.0° C. | 107.0° C. | 84.0° C. | 92.5° C. | 103.0° C. |
| Open time^{#3} | 3 min | 4 min | 35 s | 50 s | n.a.^{I} |
| Setting time^{#4} | 5 s | 5 s | 3 s | 5 s | n.a.^{I} |
| Probe Tack^{#5} | 13N | 9N | 0N | 0N | 27N |
| Flame Retardant | Reproved | — | — | E | E |
| Classification^{#6} | | | | | |

Captions :
^{A} Resin component: rosin resins
^{B} Plasticizer component: hydrotreated naphthenic oils
^{C}Polymeric component typically used in the formulation of mattress adhesives: amorphous alpha polyolefins
^{D}Alternative polymeric component: vinyl acetate polymer
^{E}Polymeric component selected for the invention: copolymer of butene, propylene and ethylene olefins
^{F}Alternative polymeric component: styrene copolymer
^{G} Antioxidant component: phenolic antioxidant
^{H} Sliding additive component: erucamide
^{I}Test not applicable to hot melt adhesives with this polymeric component
^{#1}Test method: Brookfield. Thermosel System. ASTM D3236
^{#2} Test method: Ring & Ball. ASTM E28
^{#3}Test method: MC 129 a 160° C.
^{#4}Test method: MC 129 a 160° C.
^{#5}Test method: Probe Tack. ASTM D2979-16
^{#6}Test method: DIN EN ISO 11 925-2

1. Hot melt adhesive consisting of a polymeric component consisting of at least one polyolefin thermoplastic polymer, between 2% and 4.5% by mass of a plasticizing component, a resin component, an additive component, between 0.2% and 2% by mass of an antioxidant component, wherein has a granulated or pearl shape with an open time and setting time of 50 s and 5 s, respectively, measured according to “Método Colquímica” (MC) 129 a 160° C. and additionally comprising between 0.3% and 3% by mass of an additive component, a polyolefin thermoplastic polymeric component comprises between 50% and 55% by mass of the hot melt and a resin component that comprises between 40% and 44, 5% by mass of the hot melt adhesive.

2. Hot melt adhesive according to claim 1, wherein the hot melt adhesive is flame-retardant tested in accordance with European standard DIN EN ISO 11 925 and an “E” rating was obtained.

3. Hot melt adhesive according to claim 1, wherein the at least one polyolefin thermoplastic polymer is at least one copolymer of butene, propylene and ethylene olefins.

4. Hot melt adhesive according to claim 1, wherein the resin component being selected from rosin resins, rosin glycerol ester, rosin pentaerythrol ester, rosin triethylene glycol ester or rosin methyl ester, resin of partially or fully hydrogenated rosin, tall oil resin, glycerol ester of tall oil resin, pentaerythrol ester of tall oil resin, pentaerythrol ester of tall oil resin, methanol ester of tall oil resin, polyterpene resin, phenolic terpene resin, pure monomer resin, hydrocarbon resin selected from: C5 aliphatic, C9 aromatic, C5/C9 aliphatic aromatic and dicyclopentadiene (DCPD) resins.

5. Hot melt adhesive according to claim 1, wherein the plasticizer component comprises at least one liquid plasticizer at room temperature, selected from: liquid polymers, saturated hydrocarbons, mineral oils, hydrotreated naphthenic or paraffinic oils.

6. Hot melt adhesive according to claim 1, wherein the antioxidant component comprises at least one phenolic antioxidant, phosphite antioxidant, thio-esters antioxidant or a mixture thereof.

7. Hot melt adhesive according to claim 1, wherein the additive component is a sliding additive agent component.

8. Hot melt adhesive according to claim 1, wherein the additive component comprises at least one agent selected from ethylene bisstearamide (EBS), ethylene bisoleamide (EBO), erucamide or erucic acid.

9. Hot melt adhesive according to claim 1, wherein the viscosity at 160° C. is between 1 000 and 10 000 mPa·s measured according to ASTM D3236.

10. Hot melt adhesive according to claim 1, wherein the softening point is between 50 and 130° C. measured according to ASTM E28.

11. Process for producing the hot melt adhesive claimed in claim 1, characterized in that it comprises the following steps:
mixing the plasticizer component and the resin component, at a temperature between 130 and 150° C., until a paste is formed with a homogeneous appearance;
adding the antioxidant component to the paste formed in the previous step;
sliding additive component is added immediately after the antioxidant component; and
to the mixture obtained in the previous step, adding the polymeric component with constant stirring and constant temperature, selected between 130 and 150° C., until it melts completely and the mixture presents a translucent appearance.

12. Use of the hot melt adhesive claimed in claim 1 in the sleep industry.

13. Use of the hot melt adhesive claimed in claim 1 in the construction of mattresses.
